(19) United States
(12) Patent Application Publication
(10) Pub. No.: US 2024/0284364 A1
(43) Pub. Date: Aug. 22, 2024

(54) Method and apparatus for wireless synchronization of mobile devices

(71) Applicant: Sennheiser Electronic GmbH & Co. KG, Wedemark (DE)

(72) Inventors: Sebastian Georgi, Langenhagen (DE); Jan Watermann, Hannover (DE)

(73) Assignee: Sennheiser Electronic GmbH & Co. KG, Wedemark (DE)

(21) Appl. No.: 18/571,421

(22) PCT Filed: Jun. 24, 2022
(86) PCT No.: PCT/EP2022/067300

§ 371 Date: Dec. 18, 2023

(30) Foreign Application Priority Data
Jun. 30, 2021 (DE) 10 2021 116 893.7

(51) Int. Cl. H04W 56/00; H04J 13/00; H04W 24/10

(52) U.S. Cl. CPC H04W 56/0015; H04J 13/0062; H04W 24/10

(57) ABSTRACT

The wireless communication between a base station and a mobile device is frequently based on time division multiple access methods with time slots, some of which are provided for control information. A common time base must be used for this. Since each mobile device has its own time base, it must first of all detect and correct deviations from the time base of the base station. However, the radio signals have unknown and variable transit times. In order to improve the synchronisation of a mobile device with the base station, a mobile device transmits a first synchronisation signal to the base station at a time which, according to its time base, lies in a time slot for control information. The base station measures the time of reception of the first synchronisation signal according to its own time base as a first measurement value and in the next control time slot transmits a second synchronisation signal to the mobile device, which measures the reception time according to its time base as a second measurement value. The base station also transmits the first measurement value to the mobile device. From the first and second measurement values, the mobile device determines the signal transit time and the deviation of its time base and corrects them.

### CROSS REFERENCE TO RELATED APPLICATIONS

This application is the National Stage entry under 35 U.S.C. § 371 of International Application No. PCT/EP2022/067300, filed on Jun. 24, 2022, published on Jan. 5, 2023 under Publication No. WO 2023/274861 A1, which claims the benefit of priority to German Patent Application No. 102021116893.7 filed on Jun. 30, 2021, the entireties of which are herein incorporated by reference.

### FIELD OF DISCLOSURE

The invention relates to a method for wireless synchronization of mobile devices, in particular mobile communication devices. The invention also relates to an apparatus for wireless synchronization of mobile devices.

### BACKGROUND

Mobile devices, in particular wireless mobile communication devices, can be connected to a base station via a radio connection in order to exchange information with it. Each base station is usually connected to several mobile devices or mobile devices, also designated as handsets or subscribers. The radio connection can use a proprietary or a standardized protocol and a modulation method, according to which both the base station and each of the mobile devices work. Two basic approaches to the protocol are known as frequency division multiplexing and time division multiplexing. In the simplest case, in frequency division multiplexing, each mobile device uses a continuous-time connection over a separate frequency or frequency band. In contrast, in time division multiple access (TDMA) methods, frequently designated as time division multiplexing, several or all mobile devices use the same frequency (frequencies) at different times, wherein accesses are regulated by a defined time scheme that assigns specific time slots to each subscriber. A synchronous or an asynchronous scheme can be used here; in a synchronous time scheme, each subscriber is assigned fixed time periods with cyclic repetition whilst in an asynchronous scheme there is no fixed allocation. For time division multiple access methods, however, it is generally necessary that all subscribers use a fixed, common time base. For this purpose, even the smallest deviations in the respective time base of each mobile device compared to the time base of the base station must be detected and corrected.

In most cases, there is only a radio connection between the base station and the subscribers, which has an initially unknown signal delay or latency that mainly depends on the spatial distance. This can also be disrupted by reflections and change over time since the mobile device can be moved. This raises the problem of how the mobile devices can be synchronized with the base station. Several different methods with different accuracies are known for this.

A method known for mobile communications consists in the base station sending a signal with a predefined sequence that has zero autocorrelation. So-called Zadoff-Chu sequences, for example, are suitable for this. Each mobile device correlates the received signal with the known sequence, resulting in precisely one correlation maximum due to the autocorrelation properties of the sequence. Its time is detected and used as a reference time. However, here too there is a latency that depends on the distance, depending on the transit time of the radio signal. Consequently the reference time in the mobile device has an uncertainty of, for example, one or more microseconds. Since time division multiple access methods are based on this reference time, it may therefore be necessary to leave the beginning and end of each time slot unused in order to compensate for this uncertainty and thus avoid possible collisions. In order to increase the efficiency of time division multiple access methods, more precise synchronization is necessary.

In the German patent application establishing priority, the German Patent and Trademark Office searched the following documents: U.S. Pat. No. 6,714,611 B1, U.S. Pat. No. 7,068,629 B1, WO 94/28643 A1 and WO 94/30 024 A1.

### SUMMARY OF THE INVENTION

The present invention is therefore based on the object of providing an improved method for wireless synchronization of mobile devices. The accuracy should preferably be less than 100 ns. It is assumed that the mobile device and the base station are connected via a radio connection and each have their own time base, wherein the time base of the base station should serve as a reference. Furthermore, it is assumed that the radio connection uses time slots, wherein at least one defined, cyclically repeated time slot is used for control information. Optionally, a fixed number of time slots form a frame, which is also repeated cyclically. The time base and thus the time slots of the base station and the mobile devices are initially not synchronous with one another and are synchronized according to the invention.

The object is achieved by a method according to claim 1. Claim 11 relates to an apparatus according to the invention. Further advantageous embodiments are described in the de-pendent claims 2 to 10, 12 to 16.

According to the invention, a mobile device transmits a first synchronization signal to the base station at a time that is a time slot for control information according to the time base of the mobile device. When the first synchronization signal is received in the base station, the time of reception is measured as the first measurement value according to the time base of the base station. The base station then transmits a second synchronization signal to the mobile device at a time that is a time slot for control information according to the time base of the base station. In the mobile device, the time of reception of the second synchronization signal is measured as a second measurement value according to the time base of the mobile device. In addition, the first measurement value is transmitted from the base station to the mobile device. The mobile device then calculates an average of the first and second measurement values and from this calculates a value with which it corrects its own time base so that it is synchronous with the time base of the base station.

One of the advantages of the invention is that the method is largely independent of the signal transit time of the radio signal and can even measure this. It is also advantageous that each mobile device is synchronized individually and only transmits a single short signal beforehand, in the state of inaccurate or missing synchronization. This minimizes uncoordinated transmission of signals and thus possible interference with other radio connections. Another advantage is that the synchronization can be carried out largely autonomously in the mobile device and has no influence on the base station or other mobile devices.

### BRIEF DESCRIPTION OF THE DRAWINGS

Further details and advantageous embodiments are shown in the drawings. In the figures

FIG. 1 shows an overview of a radio system;

FIG. 2 shows a frame structure of radio frames, in one embodiment;

FIG. 3 shows a structure of a radio frame, in one embodiment;

FIG. 4 shows the position of time slots for transmission data relative to time slots of the radio frame;

FIG. 5 shows a flowchart of a method according to the invention; and

FIG. 6 shows a block diagram of a mobile device.

### DETAILED DESCRIPTION OF THE INVENTION

FIG. 1 shows an overview of a radio system with a base station BS and several mobile devices TX1, RX1, TRX1, each of which is connected to the base station via a radio connection R1, R2, R3. The radio connections intermesh in time, as will be explained below. As in this example, the radio system can be used for audio data or for other user data. The radio connections are basically bidirectional, i.e. every mobile device is able to send and receive. However, the user data can be transmitted unidirectionally or bidirectionally. For example, a first mobile device TX1 is a wireless microphone that transmits audio data to the base station BS via a radio connection R1. A second mobile device RX1, on the other hand, is a wireless device for connecting a headphone or earphone and can only receive audio data from the base station via a radio connection R2, e.g. B. a so-called pocket receiver. A third mobile device TRX1 is a wireless device to which both a microphone and a headphone or earphone (for example, a headset) can be connected. It can therefore both transmit audio data to the base station and receive audio data from the base station via the radio connection R3.

The base station BS can use two or more stationary active antennae ANT1, ANT2 to increase the radio coverage of the system. These can work simultaneously in single-wave operation. In certain cases it is sufficient to use a single antenna for each individual mobile device, as explained below. The control and selection of the respective antenna can be accomplished by the base station.

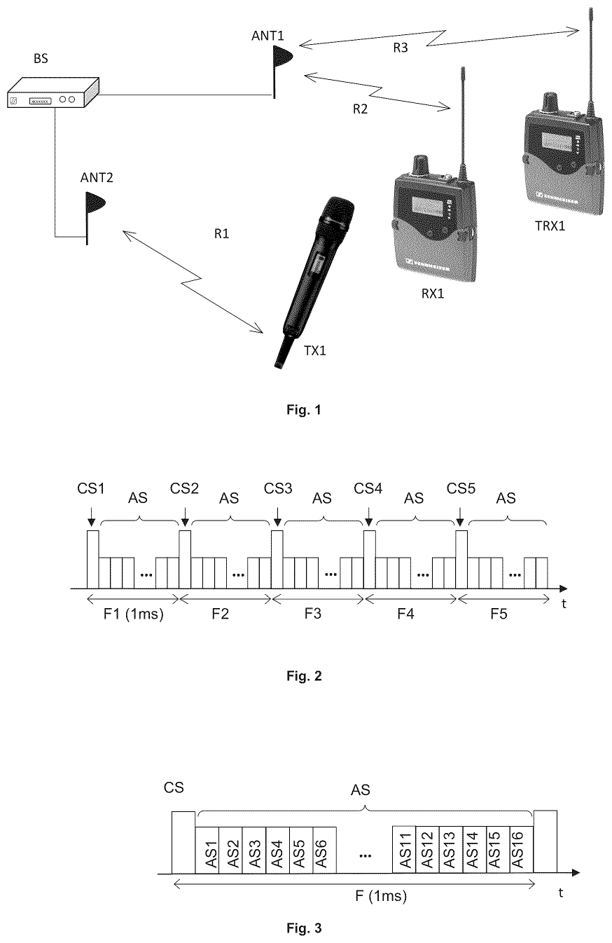

FIG. 2 shows the structure of the radio frames used. Each frame F1, . . . , F5 contains several time slots, of which one time slot CS1, . . . , CS5 is for control information and the remaining time slots AS are used for user data such as audio data. In the example of the radio system from FIG. 1, each mobile device can be assigned one or more time slots per frame for user data. FIG. 3 shows as an example a single frame F with 16 time slots for user data AS1, . . . ,AS16 (audio slots), wherein in a synchronous system, at least in the steady state or synchronized state, each frame can have the same structure. For example, the first mobile device TX1 can be assigned the time slot AS2, in which it can transmit audio data to the base station once per frame. In contrast, the second mobile device RX1 can, for example, be assigned the time slot AS3, in which it can receive audio data from the base station once per frame. In order to achieve a higher audio data rate and/or a shorter latency, further time slots can be additionally assigned to the mobile devices. For example, a further time slot can be additionally assigned to the second mobile device, e.g. AS11, in which it can also receive additional audio data from the base station once per frame. Finally, the third mobile device TRX1 is assigned at least two time slots per frame, e.g. AS4 and AS12. In one of the time slots it can receive audio data from the base station once per frame, in the other it can transmit audio data to the base station once per frame. Here too, several time slots can be used to increase the audio data rate or reduce latency. In principle, it is also possible that the second mobile device RX1 is assigned the same time slots that are assigned to the third mobile device TRX1 for receiving audio data if both mobile devices are to receive the same audio data (multicast or broadcast). Overall, this results in a time frame in which precisely one specific mobile device or the base station is allowed to transmit in each time slot according to a defined scheme, and which therefore constitutes a time division multiple access procedure (TDMA). The scheme can be flexibly changed when the radio system is initialized or when a mobile device is switched off or switched on during operation. However, the system requires that all subscribers use the same time base so that two or more subscribers do not transmit at the same time since this would then result in collisions. The synchronization required for this can be achieved according to the invention as described hereinafter.

In this example, each of the frames F1, . . . , F5 lasts 1 ms each, so that if the length of the time slots is constant, this results in a length of approximately 58.82 μs per time slot. Nat-urally, other frame structures are also possible, e.g. with several control time slots, a different duration and/or a different number of time slots for user data. Several (e.g. 8) succes-sive frames can also form a so-called superframe or overframe, whereby the occupancy of the time slots, including the use of the control time slots, can be specific to each frame of the superframe. A defined grid of control time slots is important. Since the frame structure determines the latency of the data transmission, which is particularly critical for audio and/or video data, each mobile device should be assigned a time slot as frequently as possible so that the latency is minimized. The user data can be compressed or uncompressed. For example, a user data time slot can contain compressed audio data from the last 1 ms, so that with regularly repeated transmission every 1 ms, the audio data can be reassembled completely and without gaps upon reception.

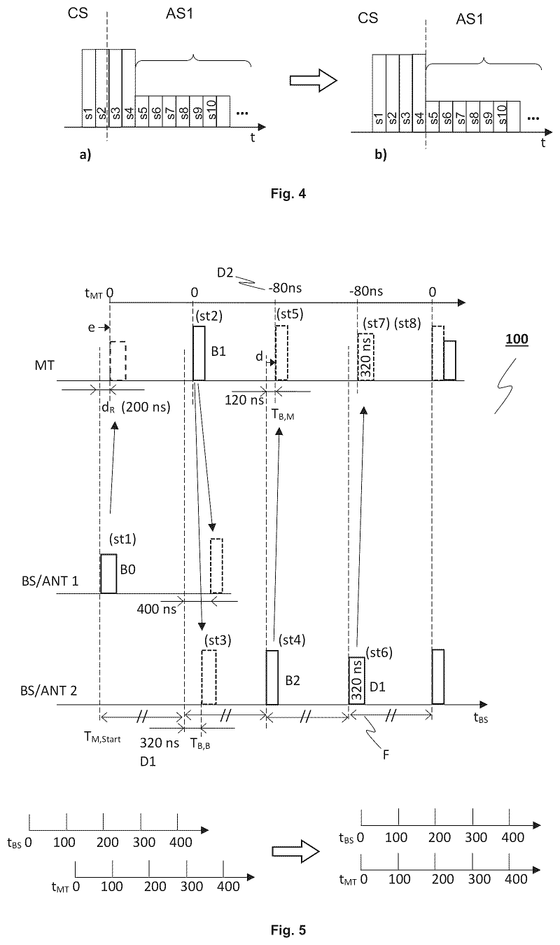

The time slots CS, AS of the radio frame are further divided into time slots for the sequential transmission of data. These are designated hereinafter as data time slots, whilst the time slots CS, AS of the radio frame are frame or TDMA time slots. FIG. 4 shows the position of data time slots s1, . . . , s10 relative to the time slots CS, AS of the radio frame. In the data time slots s1, . . . . , s10, control and user data are transmitted sequentially at high frequency. The user data can, for example, be audio samples. For example, each data time slot s1, . . . , s10 can have a length of 100 ns, so that theoretically up to 588 data values (samples) could be transmitted per TDMA time slot. However, this requires a precise assignment of the data time slots to the TDMA time slots.

In the example shown in FIG. 4, four of the data time slots s1, . . . , s4 belong in the control time slot CS, whereas six further data time slots s5, . . . , s10 belong in the first user data time slot AS1. The time base of the base station is used as a reference. However, the time base of a mobile device may differ slightly. In this case, from the perspective of the mobile device, not all data time slots are in the correct frame time slot. For example, as shown in FIG. 4a), from the perspective of the mobile device, only one of the associated data time slots s1 is clearly in the control time slot CS, whilst another data time slot s2 with control data lies partially and two further data time slots s3, s4, which also contain control data, lie completely in the user data time slot AS1. The less precise the synchronization, the more data time slots can be in the wrong TDMA time slot, leading to collisions. Therefore, a possible strategy is not to use these data time slots in the edge area of the TDMA time slots. However, with improved synchronization, more or all the data time slots can be assigned to the correct TDMA time slot in the mobile device, as shown in FIG. 4 b). This is accomplished by correcting the time base of the respective mobile device so that it is synchronous with the time base of the base station. With the improved synchronization, more or all the data time slots can be used, so that the efficiency of the system is increased. The accuracy of the synchronization should preferably be significantly higher than the width of a user data time slot, in this example 100 ns.

FIG. 5 shows, in one embodiment, a schematic flow diagram of a method according to the invention. It should be noted that in the drawings the intention is only to explain the principle and therefore the length of the frames and the time slots and their relationship to one another are not to scale. Optionally, the base station BS can transmit an initial signal B0 to the mobile device st1 via one or more of its antennae, for example ANT1, which constitutes a request to begin the synchronization process. The initial signal B0 can be transmitted in a control time slot CS, but in principle also in any time slot, e.g. when the base station and the mobile devices are in a pairing mode. The initial signal B0, or another previously transmitted control signal, may contain an individual identifier of the mobile device. The mobile device receives the initial signal after an initially unknown transit time dR, which is assumed here to be 200 ns, for example. The local time base t_{MT} of the mobile device can be roughly pre-synchronized before the initial signal B0 is received, e.g., by a modified Zadoff-Chu (Z-C) sequence described in DE 102021 113579. However, it can also be pre-synchronized with the reception of the initial signal B0 by setting it so that the reception time of the initial signal falls within a control time slot. In FIG. 5 it is assumed that the base station transmits the initial signal B0 in a time slot which is a control time slot according to the time base tes of the base station, and that the mobile device MT prelimi-narily adjusts its local time base t_{MT} with the reception of the initial signal B0.

The mobile device responds to the initial signal when the next control time slot follows according to its pre-synchronized local time base t_{MT}. Alternatively, it can also be in a defined later control time slot. The actual synchronization process begins here, whereby the mobile device transmits a first synchronization signal B1 to the base station st2. In a simple example, the time base tur of the mobile device is reset to the value zero upon receiving the initial signal B0, counts for the duration of a radio frame (TDMA frame) and starts again at zero at the beginning of the next frame. Since the control time slots CS are assumed to be at the beginning of the frame in this example, the mobile device now transmits the first synchronization signal B1 to the base station.

The base station receives st3 the first synchronization signal B1 and measures the time of reception T_{B,B} according to its own time base t_{BS}. The value measured, in the example 320 ns, is saved as a first measurement value D1. Then st4 the base station transmits a second synchronization signal B2 back to the mobile device. This takes place within the shortest possible time at a time that, according to the time base of the base station t_{BS}, lies in a time slot for control information, preferably in the next control time slot. This is advantageous because the radio channel can change over time, e.g. by moving the mobile device, reflections and interference can be added or eliminated, etc. However, the method is based on reciprocity, i.e. the transit time of the first synchronization signal B1 from the mobile device to the base station and the transit time of the second synchronization signal B2 from the base station to the mobile device should be the same.

In the next step, the mobile device st5 receives the second synchronization signal B2, the time of reception T_{B,M} being measured as a second measurement value D2 according to the time base of the mobile device t_{MT}. Since the time bases are not yet synchronous, this usually differs from the first measurement value D1, here e.g. D2=−80 ns (i.e. premature from the perspective of the mobile device). This completes the time-critical synchronization steps. Now, for example, in one of the next control time slots the first measurement value D1 is transmitted from the base station to the mobile device st6. The mobile device st7 receives this value, compares it with the second measurement value D2 and st8 corrects its time base t_{MT} so that it is synchronous with the time base t_{BS} of the base station. The accuracy corresponds to the temporal resolution of the respective time bases or the two measurement values.

The error e as the deviation between the two time bases and the actual signal transit time d are searched for (both counted positive in the direction of the time axis). The two measurement values D1, D2 represent the sum and the difference of these two values, according to D1=d+e and D2=d−e. The correction can be made by the mobile device forming an average of the first and second measurement values according to d=(D1+D2)/2, in this example (320 ns+(−80) ns)/2=120 ns. This average corresponds (under the assumptions made) to the signal transit time. In addition, the difference between the first measurement value D1 and the second measurement value D2 can be formed in the mobile device and this can be halved, in the example (320 ns−(−80)ns)12=200 ns. This difference corresponds to the error e or the deviation of the time base t_{MT} of the mobile device compared to the time base t_{BS} of the base station. Thus, the time base t_{MT} of the mobile device can be corrected by adjusting it according to the calculated deviation, in the example by −200 ns. The time base of the mobile device is then sufficiently synchronized so that all data time slots fall into the correct TDMA time slots without resulting in collisions caused by different subscribers transmitting at the same time. After correction, the deviation of the time bases can, for example, be <50 ns. If necessary, further fine-tuning can now be carried out using other methods.

The synchronization signals B1, B2 can be so-called beacon signals with a predefined, known structure or data sequence that can be clearly detected by cross-correlation of the received signal with the known data sequence such as Zadoff-Chu sequences, for example. In principle, the initial signal B0 can also be such a beacon signal. Alternatively, the initial signal B0 can be another signal and the pre-synchronization can take place beforehand with another beacon signal, e.g. a modified Z-C sequence.

Various radio or modulation methods can be used for the radio transmission of the data time slots. Multi-carrier methods such as orthogonal frequency division multiplex (OFDM) are particularly advantageous since they use a wide frequency band and are less suscep-tible to narrow-band interference. However, since various modulation methods are dis-turbed by carrier frequency offset (CFO), which can occur, for example, due to frequency drift or the Doppler effect due to a moving mobile device, a CFO measurement can be provided. Such a measurement can be carried out based on modified Z-C sequences, as described in DE 10 2021 113579. A Z-C sequence is transmitted twice in succession at a defined, short time interval, whereby the complex-valued coefficients of the sequence are once unchanged and once complex conjugate. The modified or the original Z-C sequence can be used as a beacon or synchronization signal B1, B2 for time synchronization. In this case, at least the beacon or synchronization signal B1 is preferably significantly shorter than the control time slot CS and lies approximately in the middle, so that it still lies completely within the control time slot even with the maximum possible deviation of the time bases t_{BS}, t_{MT}.

An advantage of the method is that the mobile device does not transmit any further data apart from the first synchronization signal B1 before correcting its time base. This prevents uncoordinated emission of radio signals. Therefore, with this process, additional mobile devices can be incorporated in the current radio system at any time and resynchronized in the process. In this case, if the initial signal B0 is used, this can be directed specifically to the new mobile device, which, for example, is possible through addressing. A post-synchronization of the mobile devices is also possible during ongoing operation.

The distance of the mobile device from the antenna affects the signal quality, as does for example, a possible interposed source of interference. Therefore, as in the embodiment shown in FIGS. 1 and 5, the base station for the radio connections can use at least two active antennae ANT1, ANT2. The antennae can normally operate in single-frequency mode, i.e. synchronously with one another and transmit the same signals at the same time. However, in one embodiment, only one, e.g. the most suitable antenna is selected and used. This selection can be checked and adjusted subsequently, e.g. when readjusting the synchronization. By using only one antenna, reciprocity is ensured, i.e. the same signal transit times of the first and second synchronization signals B1, B2. In principle, several or all the antennae can be used for all the other signals. The use of multiple antennae allows the transmission power of both the mobile devices and the base station to be reduced. In one embodiment, the base station receives the first synchronization signal B1 via several or all of its antennae ANT1, ANT2. The received signals of the antennae are compared and it is detected at which antenna the highest quality signal, e.g. the best signal-to-noise ratio (SNR) is received. The time of reception can also be included in the detection, although the first signal received does not necessarily provide the best signal quality. The antenna that, according to the measurement, e.g., which provides the best reception quality for the specific mobile device is selected for the respective mobile device and used to measure the first measurement value D1 and to transmit the second synchronization signal B2. However, the invention functions advantageously regardless of which antenna is selected. The initial signal B0 can in principle be transmitted by any individual antenna or by all the antennae. In the case of post-synchronization during ongoing operation, it can be advantageous to also use the antenna used for the respective mobile device for the initial signal.

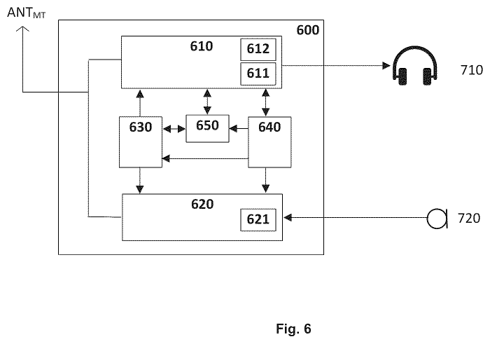

In one embodiment, the invention relates to an apparatus for synchronizing a mobile device with a base station, as shown in FIG. 6. The apparatus 650 is located in the mobile device 600, which also contains a receiver 610, a transmitter 620 and a time base module 630 as further assemblies. The time base module can be a clock, a timer, a counter or similar and can be connected to a control module 640, e.g. a processor unit. The transmitter 620 may be deactivated after switching on. Optionally, in some cases it can also be used initially to register the mobile device as a subscriber with the base station using any method, but is then deactivated. Alternatively, the mobile device can also be made known to the base station in another way, for example manually via a user interface (UI). In one embodiment, the transmitter 620 contains a generator module 621 for generating the first synchronization signal B1. In one embodiment, the receiver 610 contains a detector 611 for detecting the second synchronization signal B2 in the received signal and optionally a further detector 612 for detecting the initial signal B0 in the received signal. After switching on and, if necessary, making the mobile device known to the base station, the control module 640 can switch the mobile device 600 into a pairing mode in which, for example, it awaits an initial signal B0 from the base station. The reception of an initial signal, which the base station transmits in one embodiment specifically only for this mobile device 600, via an antenna ANT_{MT}, is reported to the control module 640 by a signal from the receiver 610 or from the detector 612. It can also be reported to the time base module 630 and pre-synchronize this. Alternatively, the time base module 630 can also be pre-synchronized by the control module 640. The time base module 630 then measures the time until the next control time slot CS and then outputs a corresponding trigger signal to the transmitter 620. The control module 640 controls the transmitter 620 so that in response to the trigger signal it transmits the first synchronization signal B1 via the antenna ANT_{MT} of the mobile device.

At the base station, the reception time of the first synchronization signal B1 is measured and stored as the first measurement value, and at the beginning of the next frame the second synchronization signal B2 is transmitted from there, as described above.

In the mobile device 600, the time base module 630 reports the start of the next frame by a trigger signal to the receiver, which then examines the received signal for the second synchronization signal B2. In addition, the time base module 630 can signal the start of the frame to the synchronization device 650. When the receiver 610 or the detector 611 detects the second synchronization signal, a signal is reported to the synchronization device 650, which receives the current time from the time base module 630 and stores it (as a second measurement value D2). Subsequently, the receiver receives the first measurement value D1 from the base station and also passes this on to the synchronization device 650. This can now calculate a signal transit time and a correction value for the time base module 630 from the received first measurement value D1 and the stored second measurement value D2, as described above, and deliver the calculated values to the control module 640 and/or directly to the time base module 630. The time base module 630 is then synchronized with the correction value so that it runs synchronously with the time base of the base station.

If the mobile device is suitable for receiving user data, such as the second and third mobile devices RX1, TRX1 shown in FIG. 1, the receiver 610 can also extract, process and output user data from the received signal according to the time base module 630, e.g. audio data via a corresponding codec and amplifier (not shown) to headphones 710. If the mobile device is suitable for transmitting user data, such as the first and third mobile devices TX1, TRX1 shown in FIG. 1, the transmitter 620 can also transmit user data, e.g. receive, process and transmit audio data from a microphone 720 via a codec (not shown) as a transmission signal according to the time base module 630.

The invention, in particular some or all the components of the mobile device 600, may be implemented with one or more configurable processors. The base station can also be implemented with one or more configurable processors. The configuration is performed by a computer-readable data carrier with instructions stored thereon which are suitable for programming the processor in such a way that it carries out the steps (in particular the steps to be carried out by the base station or by the mobile device) of the method described above.

The invention is advantageous for measuring the delay caused by a radio channel and for the temporal synchronization of mobile devices for a time division multiplex method (TDMA), in particular in a multiple antenna system. It improves synchronization when using OFDM, for example, even in highly reflective environments such as event halls. In addition, when using OFDM, the improved synchronization ensures optimal utilization of the cyclic prefix because the FFT window used during demodulation no longer detects signal components from other OFDM symbols, which would lead to more interference. Time division multiplexing can therefore be performed with smaller time tolerances, which increases efficiency and reduces latency.

1. A method for wireless synchronization of a mobile device with a base station via a radio connection, wherein the mobile device and the base station each have their own time base, wherein the time base of the base station serves as a reference, and wherein the radio connection uses a temporal sequence of time slots that form a frame, wherein at least one defined time slot of the frame is used for control information, comprising the initial step:
transmitting an initial signal from the base station to the mobile device, wherein the initial signal constitutes a request to transmit the first synchronization signal, and wherein the transmission of the first synchronization signal from the mobile device to the base station occurs in response to the received initial signal, and comprising the further steps:
transmitting a first synchronization signal from the mobile device to the base station at a time that lies in the time slot for control information according to the time base of the mobile device;
receiving the first synchronization signal in the base station, wherein the time of reception is measured as the first measurement value according to the time base of the base station;
transmitting a second synchronization signal from the base station to the mobile device at a time which lies in the next time slot for control information according to the time base of the base station;
receiving the second synchronization signal in the mobile device, wherein the time of reception is measured as the second measurement value according to the time base of the mobile device;
transmitting the first measurement value from the base station to the mobile device;
receiving the first measurement value in the mobile device; and
correcting the time base of the mobile device, wherein an average or a difference from the first and second measurement values is calculated in the mobile device and the time base of the mobile device is corrected on the basis of the average or the difference.

2. (canceled)

3. The method according to claim 2, wherein the mobile device does not transmit any further data other than the first synchronization signal before correcting its time base.

4. The method according to claim 1, wherein the base station uses at least two active antennae for the radio connections, with the additional steps
receiving the first synchronization signal sent from the mobile device to the base station at the at least two antennae;
for each of the antennae, measuring the reception quality of the received first synchronization signal;
detecting the antenna that, according to the measurement, provides the best reception quality for the mobile device; and
selecting the detected antenna, wherein the time of reception is measured at the selected antenna as the first measurement value, and wherein the transmission of the second synchronization signal from the base station to the mobile device only takes place via the selected antenna.

5. The method according to claim 4, wherein reception of the first synchronization signal at the at least two antennae, measurement of the reception quality of the received first synchronization signal for each of the antennas, detection of the antenna with the best reception quality and selection of the detected antenna is repeated at certain time intervals, wherein the detected antenna can be a different one in each case.

6. The method according to one of claims 1 to 5 claim 1, wherein the base station for several mobile devices uses the same radio connection with the same frequencies and the same frame used, wherein each mobile device is assigned one or more individual time slots per frame in which it can transmit or receive user data, and wherein the wireless synchronization is carried out separately for each mobile device.

7. The method according to claim 6, wherein the initial signal or a related control signal contains an individual identifier of the mobile device that is to be synchronized.

8. The method according to claim 1, wherein the synchronization signal contains a Zadoff-Chu sequence.

9. The method according to claim 1, wherein the base station and the mobile device are in a pairing mode.

10. The method according to claim 1, wherein the frame has a length of approximately 1 ms and each time slot has a length of at least 50 μs, and wherein the deviation of the time bases from one another is initially a maximum of 2 μs and after correcting the time base of the mobile device is less than 100 ns.

11. An apparatus for synchronizing a mobile device with a base station, wherein the mobile device includes:
a transmitter for transmitting a first synchronization signal;
a receiver for receiving a second synchronization signal and a first measurement value from the base station;
a time base module for time control of the receiver and the transmitter;
a control module for controlling the receiver, the transmitter and the time base module so that only the transmitter transmits the first synchronization signal at a time determined by the time base module sends and then the receiver first receives the second synchronization signal and then the first measurement value from the base station; and
an apparatus for synchronizing the time base module with the base station; wherein the apparatus for synchronization is adapted to
receive a second measurement value from the time base module, which indicates the receipt time of the second synchronization signal at the receiver,
to receive from the receiver the received first measurement value, which comes from the base station, and
to calculate a correction value from the two measurement values obtained by averaging and/or or difference formation and to synchronize the time base module with the correction value.

12. An apparatus according to claim 11, wherein the mobile device and the base station exchange data in time division multiplexing according to a TDMA frame containing control time slots and data time slots, and whereby the synchronization signals are transmitted in the control time slots.

13. An apparatus according to claim 11, wherein before synchronization of the time base module the mobile device does not transmit any further signals apart from transmitting the first synchronization signal once.

14. An apparatus according to claim 11, wherein the time base module controls the time of receipt of user data at the receiver and/or the time of transmission of user data by the transmitter.

15. An apparatus according to claim 11, wherein the receiver is adapted to receive an initial signal from the base station, wherein the initial signal constitutes a request or release to transmit the first synchronization signal, and wherein the transmitter transmits the first synchronization signal to the base station in response to the received initial signal.

16. A computer-readable data carrier with instructions stored thereon which are suitable for programming a computer or processor in such a manner that it carries out the steps of the method according to claim 1 to be carried out by the mobile device.
